(19) United States
(12) Patent Application Publication
(10) Pub. No.: US 2006/0018238 A1
(43) Pub. Date: Jan. 26, 2006

(54) Fabrication of digital media using electron beam technology

(76) Inventors: John A. Trepl II, Dana Point, CA (US); Charles Marshall, Burbank, CA (US); Roger A. Kuntz, Laguna Niguel, CA (US); Axel M. Kuntz, Lake Forest, CA (US)

Correspondence Address: Zilka-Kotab, PC, P.O. BOX 721120, SAN JOSE, CA, 95172-1120, US

(21) Appl. No.: 10/897,276

(22) Filed: Jul. 21, 2004

(51) Int. Cl. G11B 9/00

(52) U.S. Cl. 369/126

(57) ABSTRACT

A method for writing data to an optical medium includes directing intermittent pulses of a beam of electrons from an electron source onto an optical medium in a controlled pattern for creating surface features on the optical medium, the surface features representing data. A system for performing this method, according to one embodiment, includes a medium receiving portion for holding an optical medium, an electron source for emitting a beam of electrons at the optical medium on the medium receiving portion, and a steering mechanism for directing the electron beam onto the optical medium in a controlled manner. The beam of electrons strikes the optical medium in intermittent pulses for creating surface features on the optical medium, the surface features representing data.

### FIELD OF THE INVENTION

The present invention relates to digital media manufacturing systems and more particularly, this invention relates to manufacturing digital media using electron beam technology.

### BACKGROUND OF THE INVENTION

Optical media presently include compact discs (CDs), digital video discs (DVDs), laser discs, and specialty items. Optical media has found great success as a medium for storing music, video and data due to its durability, long life, and low cost.

A CD typically comprises an underlayer of clear polycarbonate plastic. During manufacturing, the polycarbonate is injection molded against a master having protrusions (or pits) in a defined pattern that creates an impression of microscopic bumps arranged as a single, continuous, spiral track of data on the polycarbonate. Then, a thin, reflective aluminum layer is sputtered onto the disc, covering the bumps. Next a thin acrylic layer is sprayed over the aluminum to protect it. A label is then printed onto the acrylic. FIG. 1 illustrates a cross section of a typical data or audio CD 100, particularly depicting the polycarbonate layer 102, aluminum layer 104, acrylic layer 106, label 108, and pits 110 and lands 112 that represent the data stored on the CD 100. Note that the “pits” 110 are as viewed from the aluminum side, but on the side the laser reads from, they are bumps. The elongated bumps that make up the data track are each 0.5 microns wide, a minimum of 0.83 microns long and 125 nanometers high. The dimensions of a standard CD is about 1.2 millimeters thick and about 4.5 inches in diameter. A CD can hold about 740 MB of data.

During playback, the reader's laser beam passes through the polycarbonate layer, reflects off the aluminum layer and hits an opto-electronic device that detects changes in light. The bumps reflect light differently than the lands, and an opto-electronic sensor detects that change in reflectivity. The electronics in the reader interpret the changes in reflectivity in order to read the bits that make up the data.

The data stored on the CD is retrieved by a CD player that focuses a laser on the track of bumps. The laser beam passes through the polycarbonate layer, reflects off the aluminum layer and hits an opto-electronic device that detects changes in light. The bumps reflect light differently than the lands, and the opto-electronic sensor detects that change in reflectivity. The electronics in the drive interpret the changes in reflectivity in order to read the bits that make up the bytes.

A DVD is very similar to a CD, and is created and read in generally the same way (save for multilayer DVDs, as described below). However, a standard DVD holds about seven times more data than a CD.

Single-sided, single-layer DVDs can store about seven times more data than CDs. A large part of this increase comes from the pits and tracks being smaller on DVDs. Table 1 illustrates a comparison of CD and DVD specifications.

TABLE 1

| Specification | CD | DVD |
|---|---|---|
| Track Pitch | 1600 nanometers | 740 nanometers |
| Minimum Pit Length (single-layer | 830 nanometers | 400 nanometers |
| DVD) | | |
| Minimum Pit Length (double-layer | 830 nanometers | 440 nanometers |
| DVD) | | |

To increase the storage capacity even more, a DVD can have up to four layers, two on each side. The laser that reads the disc can actually focus on the second layer through the first layer. Table 2 lists the capacities of different forms of DVDs.

TABLE 2

| Format | Capacity | Approx. Movie Time |
|---|---|---|
| Single-sided/single-layer | 4.38 GB | 2 hours |
| Single-sided/double-layer | 7.95 GB | 4 hours |
| Double-sided/single-layer | 8.75 GB | 4.5 hours |
| Double-sided/double-layer | 15.9 GB | Over 8 hours |

A DVD is composed of several layers of plastic, totaling about 1.2 millimeters thick. FIG. 2 depicts the cross section of a single sided/double-layer DVD 200. Each layer is created by injection molding polycarbonate plastic against a master, as described above. This process forms a disc 200 that has microscopic bumps arranged as a single, continuous and extremely long spiral track of data. Once the clear pieces of polycarbonate 202, 204 are formed, a thin reflective layer is sputtered onto the disc, covering the bumps. Aluminum 206 is used behind the inner layers, but a semi-reflective gold layer 208 is used for the outer layers, allowing the laser to focus through the outer and onto the inner layers. After all of the layers are made, each one is coated with lacquer, squeezed together and cured under infrared light. For single-sided discs, the label is silk-screened onto the nonreadable side. Double-sided discs are printed only on the nonreadable area near the hole in the middle. Cross sections of the various types of completed DVDs (not to scale) look like this

A DVD player functions similarly to the CD player described above. However, in a DVD player, the laser can focus either on the semi-transparent reflective material behind the closest layer, or, in the case of a double-layer disc, through this layer and onto the reflective material behind the inner layer. The laser beam passes through the polycarbonate layer, bounces off the reflective layer behind it and hits an opto-electronic device, which detects changes in light.

One problem with each of these technologies is that it is very expensive and time consuming to create the master. Another problem is that if the master is not perfectly formed, none of the discs created from it will work properly. Further, as shown in FIG. 3A, the bumps 302 on the master 300 must be beveled so that the polycarbonate 304 releases from the master 300. This beveling places limits on the size of the surface features, as reading ability is reduced as the amount of beveling moves from 90 degrees.

Another problem is that the ends 306 of the bumps 302 of the master are also rounded, as shown in FIG. 3B, to aid in separation of the master 300 from the polycarbonate 304. However, the rounded edge causes jitter during the playback. In fact, >50% of jitter can be attributed to the rounded edges.

CDs and DVDs also come in the form of recordable discs. CD-recordable discs (CD−Rs) and DVD-recordable discs (DVD±Rs), do not have any bumps or flat areas (pits or lands). Instead, as shown on the cross section of a recordable disc 400 in FIG. 4, they have a smooth reflective metal layer 402, which rests on top of a layer of photosensitive dye 404, a layer of polycarbonate 406 under the dye, and a backing layer 408. When the disc is blank, the dye is translucent: light can shine through and reflect off the metal surface. The write laser darkens the spots 410 where the bumps would be in a conventional CD or DVD, forming non-reflecting areas. This is known as “burning” a disc. By selectively darkening particular points 410 along the data track, and leaving other areas of dye translucent, a digital pattern is created that is readable by a standard CD or DVD player. The light from the player's laser beam will only bounce back to the sensor when the dye is left translucent, in the same way that it will only bounce back from the flat areas of a conventional CD or DVD.

In place of the CD−R and DVD−R disc's dye-based recording layer, CD−RW and DVD±RW use a crystalline compound made up of a mix of silver, indium, antimony and tellurium. When this combination of materials is heated to one temperature and cooled it becomes crystalline, but if it is heated to a higher temperature, when it cools down again it becomes amorphous. The crystalline areas allow the reflective layer to reflect the laser better while the non-crystalline portion absorbs the laser beam, so it is not reflected.

In order to achieve these effects in the recording layer, the disc recorder use three different laser powers: the highest laser power, which is called “Write Power”, creates a non-crystalline (absorptive) state on the recording layer; the middle power, also known as “Erase Power”, melts the recording layer and converts it to a reflective crystalline state; and the lowest power, which is “Read Power”, does not alter the state of the recording layer, so it can be used for reading the data.

During writing, a focused “Write Power” laser beam selectively heats areas of the phase-change material above the melting temperature (500-700° C.), so all the atoms in this area can move rapidly in the liquid state. Then, if cooled sufficiently quickly, the random liquid state is “frozen-in” and the so-called amorphous state is obtained. The amorphous version of the material shrinks, leaving a pit where the laser dot was written, resulting in a recognizable CD or DVD surface. When an “Erase Power” laser beam heats the phase-change layer to below the melting temperature but above the crystallization temperature (200 ° C.) for a sufficient time (at least longer than the minimum crystallization time), the atoms revert back to an ordered state (i.e., the crystalline state). Writing takes place in a single pass of the focused laser beam; this is sometimes referred to as “direct overwriting” and the process can be repeated several thousand times per disc.

One problem with recordable optical media is that burning takes a long time, making replication of discs by this method very inefficient. For example, it takes over 2 minutes to burn a 640 MB CD−R at 48×normal read speed. It takes 14-16 minutes to burn a single side, single layer DVD±R. These times do not include the other processing time, such as the time it takes to open the drive door, load the disc, close the door, initiate the drive, then after burning open the door, remove the disc, etc.

Another problem with recordable media is that the writing laser inherently produces dye spots with rounded edges. As mentioned above, rounded edges create jitter.

What is therefore needed is a way to improve the write speed for optical media.

What is also needed is a way to create near-90 degree transitions between bumps and lands so that the data density along the data track can be increased.

What is further needed is a way to write media in a way that the surface features have near-straight edges.

### SUMMARY OF THE INVENTION

To overcome the aforementioned drawbacks and provide the desirable advantages, a method for writing data to an optical medium includes directing intermittent pulses of a beam of electrons from an electron source onto an optical medium in a controlled pattern for creating surface features on the optical medium, the surface features representing data.

A system for performing this method, according to one embodiment, includes a medium receiving portion for holding an optical medium, an electron source such as an electron gun for emitting a beam of electrons at the optical medium on the medium receiving portion, and a steering mechanism for directing the electron beam onto the optical medium in a controlled manner. The beam of electrons strikes the optical medium in intermittent pulses for creating surface features on the optical medium, the surface features representing data.

The system described herein can write data such as audio data, video data, software, etc. to an optical medium very quickly, e.g., in less than one minute, and even in less than one second. The system is able to write data to any type of optical media, including those readable by consumer-grade CD and DVD players. Suitable optical media include any type of commercially available medium, including CD, DVD, laser disc, recordable discs (e.g., CD-R, CD-RW, DVD+R, DVD−R, DVD+RW, DVD−RW), or any type of medium from which data is read optically.

If the optical medium is a disc, the pattern preferably has a generally spiral shape. In one embodiment, the medium comprises a substantially transparent layer and a reflective layer, the electron pulses damaging the reflective layer. In another embodiment, the medium comprises a substantially transparent layer and a reflective layer, the electron pulses creating pits in the substantially transparent layer, the reflective layer being added after the surface features are created. In a further embodiment, the medium comprises a reflective layer, and a dye layer being substantially transparent in an unexposed state, the electron pulses creating darkened portions of the dye layer. In yet another embodiment, the surface features are created on at least two layers of the optical medium, as in a double layer DVD.

By controlling the power and width of the pulses, the system can create surface features readable by current optical media readers as well as proprietary readers. In any of these methods, the surface features can be made significantly smaller than has heretofore been possible, even using commercially available media. This is due to the fine detail (e.g., ˜5 nanometer) and sharp edges afforded by electron beam technology. For instance, the surface features can have a length along a data track thereof of less than about 500 nanometers, less than about 200 nanometers, less than about 100 nanometers, and less than about 50 nanometers. In this way, the data storable on a single medium can be greatly improved, limited only by the wavelength of the optical system used. For finer surface features, for example, ultraviolet, microwave and x-ray optical systems may be required.

The beam can be directed in the controlled pattern via magnetic fields generated by steering coils. In one embodiment, the pulses are generated by controlling a grid voltage of the electron source. In another embodiment, the pulses are generated by beam blanking.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a partial cross sectional view, not to scale, of a CD.

FIG. 2 is a partial cross sectional view, not to scale, of a single sided, dual-layer DVD.

FIG. 3A is a partial cross sectional view, not to scale, of a master and polycarbonate layer.

FIG. 3B is a partial cross sectional view, not to scale, taken along line 3B-3B of FIG. 3A.

FIG. 4 is a partial cross sectional view, not to scale, of a recordable medium.

FIG. 5 is a representative system diagram of a system for writing data to an optical medium according to one embodiment.

FIG. 6 is a flow diagram of a method for writing data to a standard CD or a single or double sided, single layer (per side) DVD according to an illustrative embodiment.

FIG. 7 is a flow diagram of a method for writing data to a CD or a single or double sided, single layer (per side) DVD according to an illustrative embodiment.

FIG. 8 is a flow diagram of a method for writing data to a single sided, double layer (per side) DVD according to an illustrative embodiment.

FIG. 9 is a flow diagram of a method for writing data to a recordable disc, such as a commercially available recordable CD or DVD according to an illustrative embodiment.

FIG. 10 is a side view of a surface feature created by an electron beam.

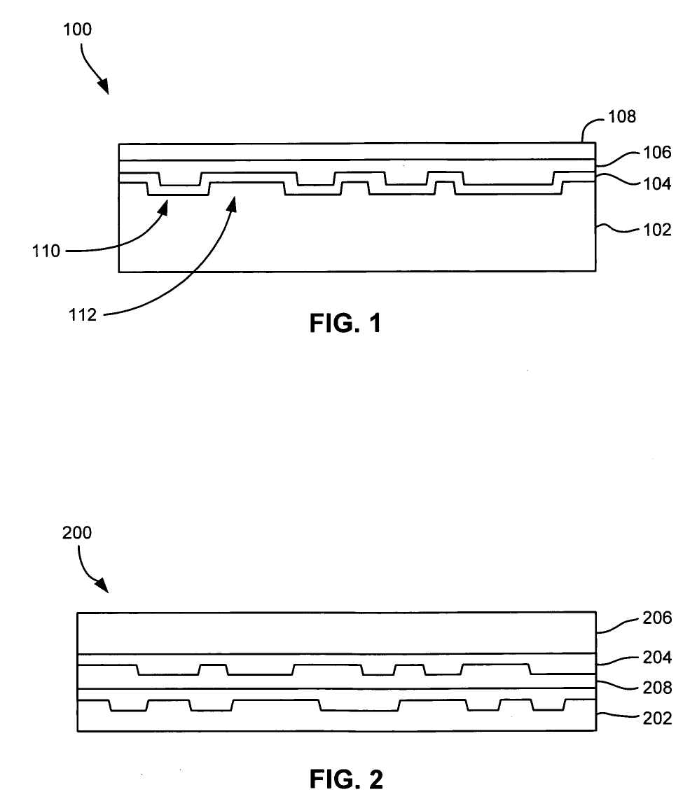

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

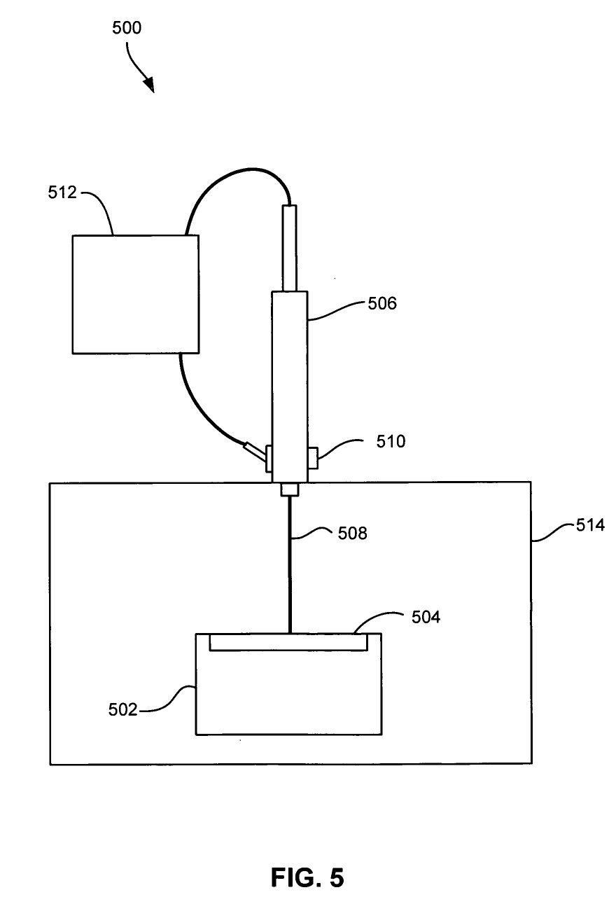

FIG. 5 illustrates a system 500 for writing data to an optical medium according to one embodiment. The system 500 includes a medium receiving portion 502 for holding a target optical medium 504, an electron source 506 such as an electron gun for emitting a beam of electrons 508 at the optical medium on the medium receiving portion 502, and a steering mechanism 510, which may be integral with the gun 506, for directing the electron beam 508 onto the optical medium 504 in a controlled manner such as in a spiral, concentric circles, straight lines, etc. A controller 512 controls operation of the system components. The beam of electrons 508 is made to strike the optical medium 504 intermittently so that surface features are created on the optical medium 504. Particularly, the electron beam 508 displaces or oblates the material it strikes, creating pits. The resultant pits and lands along the data track represent data. At least the medium receiving portion 502 should be positioned in a vacuum chamber 514 maintained at a vacuum of 1×10⁻³ Torr or less. Note that the emitting portion of the gun 506 should also be positioned in the vacuum chamber 514.

Accordingly, standard e-beam lithography machine sinter technology can be combined with raster image control technology to write an image pattern to target media, thereby combining the fine feature size detail of electron beam lithography with the imaging speed of the rastering.

The system described herein can write data such as audio data, video data, software, etc. to an optical medium very quickly, e.g., in less than one minute, and even in less than one second. The system is able to write data to any type of optical media, including those readable by consumer-grade CD and DVD players. Suitable optical media include any type of commercially available medium, including CD, DVD, laser disc, recordable discs (e.g., CD-R, CD-RW, DVD+R, DVD−R, DVD+RW, DVD−RW), or any type of medium from which data is read optically. Of course, the technology disclosed herein would extend to future types of optical media that are presently under development or have yet to be discovered.

Electron guns have been widely used in the semiconductor industry to define electronic components with features down to about 5 nanometers. Such guns are suitable for use in the present invention. In general, an electron gun includes a small heater that heats a cathode. When heated, the cathode emits a cloud of electrons. Two anodes turn the cloud into an electron beam. An accelerating anode attracts the electrons and accelerates them toward the target (here, an optical medium) at a very high speed. A focusing anode, e.g., deflection plates and Einzel lens, focuses the stream of electrons into a very fine beam. By adjusting the power to the accelerating anode, the speed of the electrons, and thus their energy, can be set to create the desired depth of the pits being created on the medium. By adjusting the power to the heater, the number of electrons emitted can be controlled, which in turn affects the depth and width of the pits.

Many cathode types and sizes are available: tantalum disc cathodes, tungsten hairpins, single-crystal lanthanum hexaboride (LaB₆) cathodes, barium oxide (BaO) cathodes, or thoria-coated (ThO₂) iridium cathodes. UHV technology is preferably used throughout. The guns can be run in vacuums from 10⁻¹¹ torr up to 10⁻⁵ torr for the various refractory metal cathodes. A minimum vacuum recommended for LaB₆ or BaO cathodes is roughly 1×10⁻⁷ torr. Thoria cathodes can be run up to 10⁻⁴ torr and above

Suitable electron guns include the EGG-3101, EGPS-3101, EMG-12, and EGPS-12 available from Kimball Physics, 311 Kimball Hill Road, Wilton, N.H. 03086-9742 USA. One skilled in the art will recognize that there are several manufacturers of electron guns that are also suitable for use with the system, including those having larger and smaller spot sizes.

The steering mechanism can use rastering technology to aim the electron beam at the optical medium along the data path. One preferred steering mechanism includes steering coils under control of the controller. Steering coils are copper windings that create magnetic fields that affect the direction of the electron beam. One set of coils creates a magnetic field that moves the electron beam in the X direction, while another set moves the beam in the Y direction. By controlling the voltages in the coils, the electron beam can be positioned at any point on the medium. Because rastering can be performed very quickly, a full data track can be transferred to the optical medium in a fraction of a second.

The raster pattern can be generated by a computer using a standard X-Y grid corresponding to points on the medium. The grid has a density sufficient to allow writing to all necessary points on the medium. The steering mechanism, in turn, directs the electron beam to the points on the medium corresponding to data points on the grid, where a pulse is emitted. A simple raster controller in this type of system can be similar to the controller used in cathode ray tubes (CRTs).

Alternatively, the raster pattern can be set to follow a data track, such as a spiral. The steering coils are energized in such a way that the electron beam moves along the data track, the electron beam pulsing at selected points along the data track. In this type of system, for example, the field emitted by the steering coils in the X and Y directions can follow generally sinusoidal curves where the amplitudes of the curves gradually increase as the beam moves from the inner diameter of the media to its periphery along a spiral data track.

As mentioned above, the surface features are created by electron beam pulses. In most electron guns, including those available from Kimball Physics, the electron beam may be turned off and on while the gun is running. The way this is accomplished depends on the particular gun design. Often several beam pulsing methods are available for a particular gun.

Pulsing includes stopping and starting the flow of electrons in a fast cycle. This pulsing is usually accomplished by rapidly switching the grid voltage to its cut off potential to stop the beam. The grid provides the first control over the beam and usually can be used to shut off the beam. In an electron gun, if the grid voltage is sufficiently negative with respect to the cathode, it will suppress the emission of the electrons, first from the edge of the cathode and at higher (more negative) voltages from the entire cathode surface. The minimum voltage required to completely shut off the flow of electrons to the target is called the grid cut off. The grid voltage can be controlled by the controller manipulating the power supply; thus, in most guns, the beam can be turned off while the gun is running by setting the grid to the cut off voltage.

The grid voltage can be controlled by several different methods, one being capacitive. Many guns can be equipped with a capacitor-containing device (either a separate pulse junction box or cylinder, or a cable with a box) that receives a signal from an external pulse generator (available from the gun manufacturer). The grid power supply and pulse generator outputs are superimposed to produce the voltage at the grid aperture. The general pattern of the beam pulsing is a square wave with a variable width (time off and time on) and a variable repetition rate. Capacitive pulsing can provide the fastest rise/fall time and shortest pulse length of the various methods. However, the capacitor does not permit long pulses or DC operation. If there is a separate grid lead on the gun, this capacitive pulsing option can be added to most existing gun systems without modification.

A typical pulse length is ˜20-100 nanoseconds, defined as the time the beam is on, measured as the width at 50% of full beam and may include some ringing. The rise/fall time is typically ˜10 nanoseconds measured between 10% and 90% of full beam. Shortening the rise/fall will typically increase ringing. Pulsing performance may also depend on the performance of the user-supplied pulse generator.

Not all guns are designed to be pulsed. For example, a few electron guns have a positive grid in order to extract more electrons, and so these guns do not usually have grid cut off, unless a dual grid supply is ordered. In some high-current electron guns, the optical design, the position of the cathode, does not allow for cut-off with the grid, and so a different option, called blanking, must be used to interrupt the beam instead of pulsing.

Beam blanking deflects the electron beam to one side of the electron gun tube to interrupt the flow of electrons to the target without actually turning off the beam. The voltage applied to the blanker plate in the gun is controlled by a potentiometer on the power supply. Blanking can be used to pulse the final beam current repeatedly on and off in response to a TTL signal input. The blanker voltage required for beam cutoff depends on the gun configuration and on the beam energy, and can be readily determined from the reference materials accompanying the electron gun from the manufacturer.

As mentioned above, the system 500 can write data to commercially available media, recordable media, and specialty media. How the system a100 writes data to commercially available media such as CDs and DVDs will be discussed first.

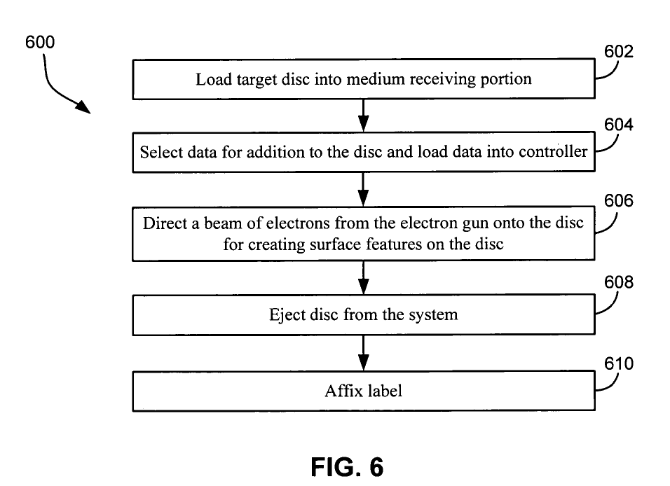

FIG. 6 depicts a method 600 for writing data to a standard CD or a single or double sided, single layer (per side) DVD. In operation 602, the target disc is loaded into the medium receiving portion either manually or by an automated system. The medium receiving portion preferably holds the target disc in a fixed position so that movement is eliminated.

As mentioned above, a CD and DVD typically comprises a clear polycarbonate plastic underlayer, a thin, reflective aluminum layer sputtered onto the polycarbonate, and a thin protective layer, e.g., acrylic, lacquer, etc. sprayed over the aluminum to protect it. In this method 600, the target disc as loaded into the system comprises polycarbonate, a reflective layer, and acrylic backing. The acrylic backing faces the electron gun. In operation 604, data is selected for addition to the disc and loaded into the controller. In operation 606, under control of the controller, a beam of electrons from the electron gun is directed onto the disc for creating surface features on the disc. The electron beam is caused to pulse intermittently in a controlled manner to create the surface features along the data track, the surface features representing data in a data track. The resulting data track is a spiral pattern starting from the inner diameter of the disc. The power of the electron beam is set such that it will pierce the backing layer and create optically discernable features on the reflective layer so that the reader will only detect reflections from the nonexposed parts of the reflective layer, thereby creating surface features along the data track. For a CD, the data points are about 0.5 microns (500 nanometers) wide, and a minimum of 0.83 (830 nanometers) microns long. The track spacing is about 6 microns (6000 nanometers). In a DVD, the damaged sections of the reflective layer that make up the data track are each about 320 nanometers wide and a minimum of 400 nanometers long. The track spacing is about 740 nanometers.

In operation 608, the disc is ejected from the system. In operation 610, a label is then printed onto the acrylic using a printing device known in the art, or affixed as an adhesive layer. In this way, the damaged area of the disc is covered and is nonapparent to the end user. The side of the label adjacent the disc is preferably nonreflective so as not to reflect the reader's laser during playback. Also note that a protective layer can optionally be added prior to affixing the label.

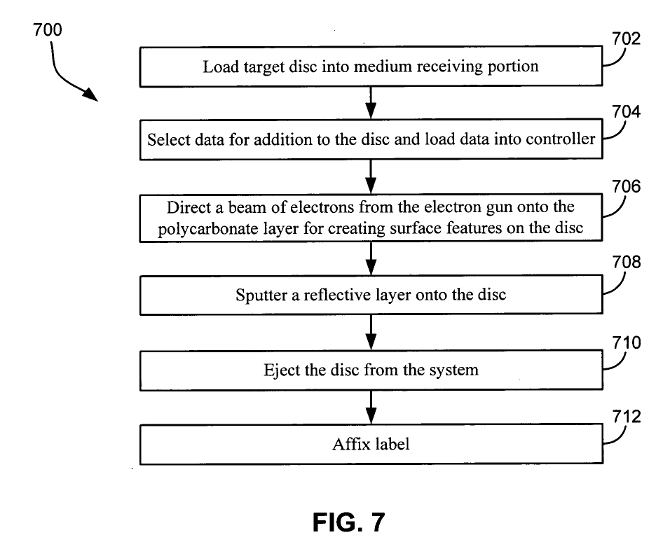

FIG. 7 depicts a method 700 for writing data to a CD or a single or double sided, single layer (per side) DVD. In this method, the disc comprises a substantially transparent polycarbonate layer as loaded into the medium receiving portion. Note operation 702. In operation 704, data is selected for addition to the disc and loaded into the controller. In operation 706, under control of the controller, intermittent pulses of a beam of electrons from the electron gun are directed onto the polycarbonate layer for creating surface features on the disc, the surface features representing data in a data track. The power of the electron beam is set such that it creates pits in the polycarbonate layer. For a CD, the pits are set at about 125 nanometers deep. For a DVD, the pits are set at about 120 nanometers deep.

Again, the electron beam is pulsed in a controlled manner to create the surface features along the data track. For a CD, the pits are about 0.5 microns (500 nanometers) wide, and a minimum of 0.83 (830 nanometers) microns long. The track spacing is about 6 microns (6000 nanometers). In a DVD, the pits are each about 320 nanometers wide, a minimum of 400 nanometers long. The track spacing is about 740 nanometers.

In operation 708, a reflective layer is sputtered onto the disc. In operation 710, the disc is ejected from the system. In operation 712, a label is then printed onto the acrylic using a printing device known in the art, or affixed as an adhesive layer.

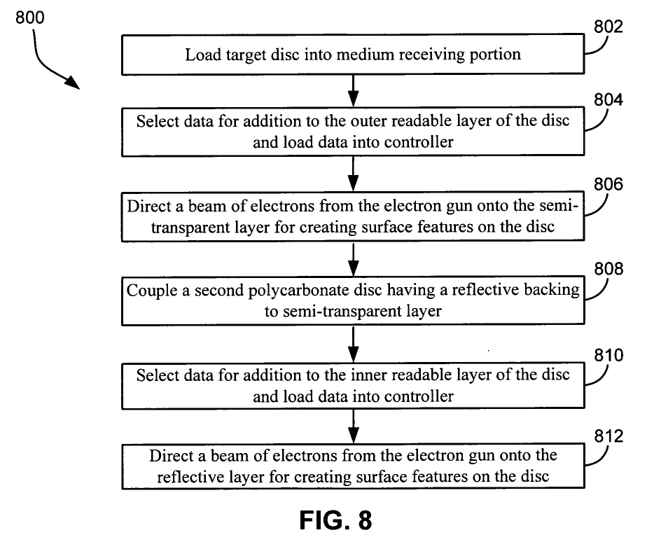

FIG. 8 depicts a method 800 for writing data to a single sided, double layer (per side) DVD. In this method, a first substantially transparent polycarbonate layer having a semi-transparent layer, preferably of gold, is loaded into the medium receiving portion. Note operation 802. This is the outer readable layer. The semi-transparent layer faces the electron gun. In operation 804, data is selected for addition to the outer readable layer of the disc and loaded into the controller. In operation 806, under control of the controller, intermittent pulses of a beam of electrons from the electron gun are directed onto the semi-transparent layer for creating surface features on the disc, the surface features representing data in a data track that is readable as the outer data track. In operation 808, a second polycarbonate disc having a reflective backing is coupled to the semi-transparent layer. The reflective backing faces the electron gun.

In operation 810, data is selected for addition to the inner readable layer of the disc and loaded into the controller. In operation 812, under control of the controller, intermittent pulses of a beam of electrons from the electron gun are directed onto the reflective layer for creating surface features on the disc, the surface features representing data in a data track that is readable as the inner data track. Then additional steps, such as adding an acrylic backing and label can be performed.

This method 800 has the advantage that the disc does not move, and the electron gun does not move. Thus, the inner and outer readable layers are inherently aligned perfectly every time.

The process can be repeated to create two additional data layers which can be coupled to the first and second polycarbonate discs, thereby creating a dual side, double layer DVD.

Likewise, the method of 700, where the transparent layers are damaged by the electron beam, can be adapted to create multi-level optical media, as will be apparent to one skilled in the art. In this situation, the transparent layer of the outer readable layer is first written to, and a semi-transparent layer is sputtered onto it. A second transparent layer (inner readable layer) is coupled to the semi-transparent layer and data written thereto. A reflective layer is then sputtered onto the second transparent layer followed by labeling or addition of other layers.

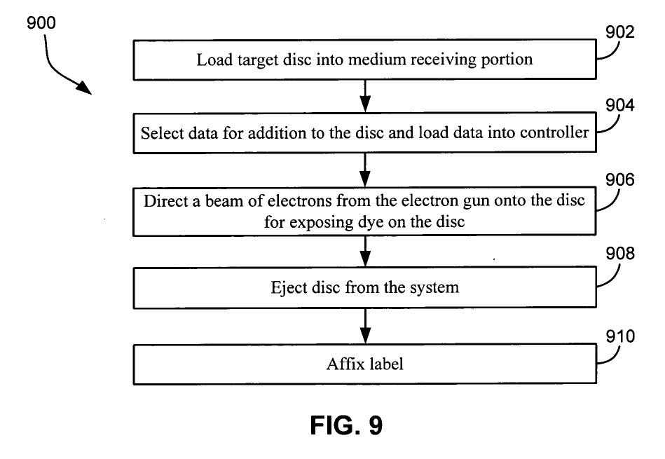

FIG. 9 depicts a method 900 for writing data to a recordable disc, such as a commercially available recordable CD or DVD. In this method, the disc comprises a substantially transparent layer, a dye layer, and a reflective layer as loaded into the medium receiving portion, the reflective layer facing the electron gun. Note operation 902. In operation 904, data is selected for addition to the disc and loaded into the controller. In operation 906, under control of the controller, intermittent pulses of a beam of electrons from the electron gun are directed onto the disc for exposing the dye in the dye layer. The exposed dye darkens, thereby creating surface features representing data in a data track. The power of the electron beam is preferably set such that it pierces the reflective layer and exposes the dye, but does not significantly damage the underlying transparent layer. Again, the electron beam is pulsed in a controlled manner to create the surface features along the data track. In operation 908, the disc is ejected from the system. In operation 910, a label is then printed onto the acrylic using a printing device known in the art, or affixed as an adhesive layer.

This method can also be used to write to rewritable discs, e.g., CD-RW and DVD±RW. In that case, the power of the electron beam is set to heat areas of the phase-change material above the melting temperature (500-700° C.), so all the atoms in this area can move rapidly in the liquid state. Then, if cooled sufficiently quickly, the random liquid state is “frozen-in” and the so-called amorphous state is obtained. The amorphous version of the material shrinks, leaving a pit where the data point was written by the electron beam, resulting in a recognizable CD or DVD surface.

One skilled in the art will appreciate that the various operations of the methods described above can be combined to create additional methods for writing data to optical media, such additional method being considered within the scope of the present invention. One skilled in the art will also appreciate that the methods can be adapted with software instructions to write to types of media other than disc shaped media.

In any of these methods, the surface features can be made significantly smaller than has heretofore been possible, even using commercially available media. This is due to the fine detail (e.g., ˜5 nanometer) and sharp edges afforded by electron beam technology. For instance, the surface features can have a length along a data track thereof of less than about 500 nanometers, less than about 200 nanometers, less than about 100 nanometers, and less than about 50 nanometers. In this way, the data storable on a single medium can be greatly improved, limited only by the wavelength of the optical system used. For discs having surface features finer than a DVD, a reader capable of reading finer-than-DVD features is used. For even finer surface features, for example, ultraviolet, microwave and x-ray optical systems may be required.

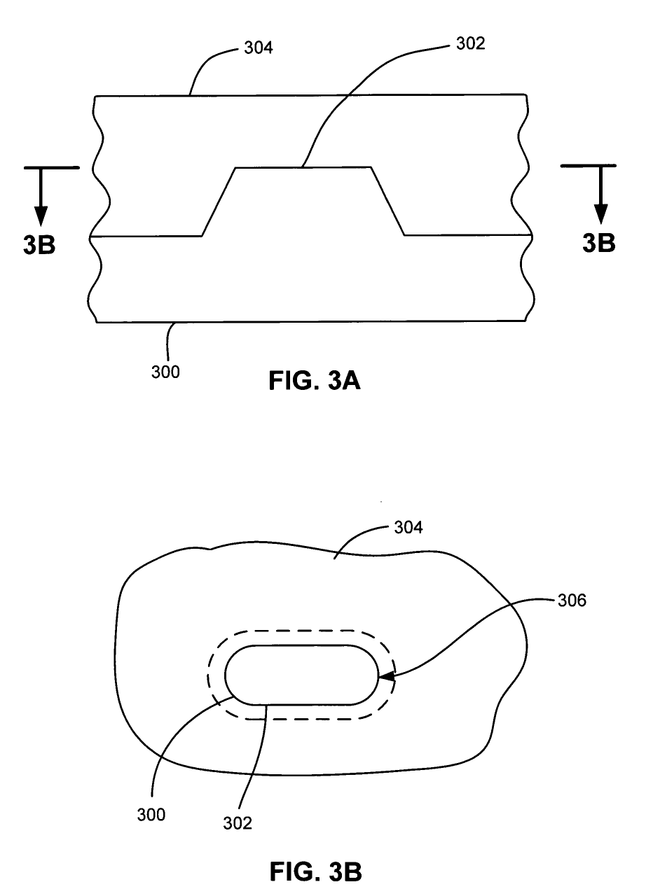

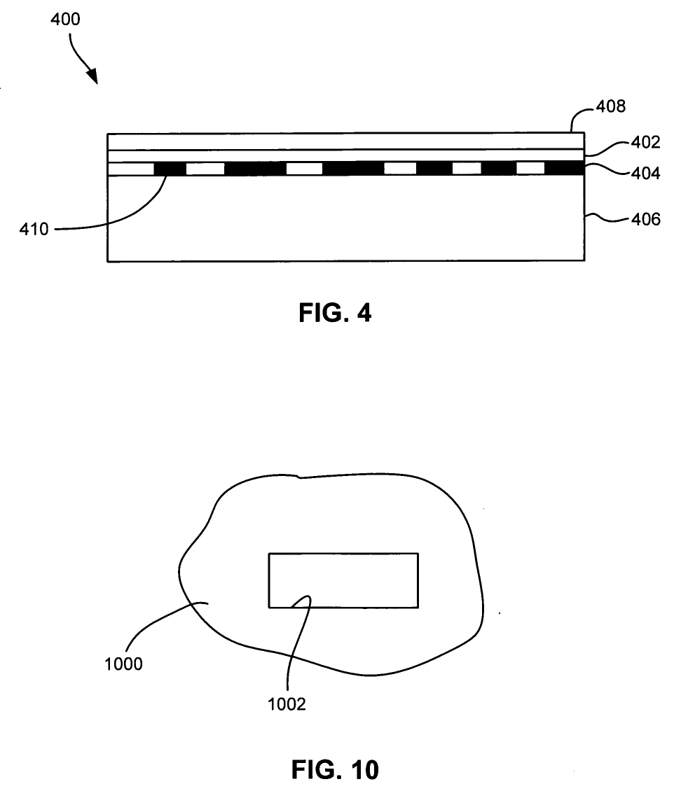

Also note that the surface features created can have almost perfectly straight edges. FIG. 10 illustrates a surface of a media 1000 formed as above having a surface feature 1002 formed by an electron beam. Comparing the media 1000 in FIG. 10 to FIG. 3B, it is seen that the electron beam-create surface features 1002 have very straight edges and sharp corners. The resultant media have been found to have much less jitter than optical media heretofore known.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for writing data to an optical medium, comprising:
directing intermittent pulses of a beam of electrons from an electron source onto an optical medium in a controlled pattern for creating surface features on the optical medium, the surface features representing data.

2. The method as recited in claim 1, wherein the optical medium is a disc.

3. The method as recited in claim 2, wherein the pattern has a generally spiral shape.

4. The method as recited in claim 2, wherein the optical medium is readable by a consumer-grade compact disc (CD) player.

5. The method as recited in claim 2, wherein the optical medium is readable by a consumer-grade digital video disc (DVD) player.

6. The method as recited in claim 1, wherein the optical medium is readable by a reader capable of reading surface features finer than a consumer-grade digital video disc (DVD) player.

7. The method as recited in claim 1, wherein the medium is a commercially available compact disc.

8. The method as recited in claim 1, wherein the medium is a commercially available digital video disc.

9. The method as recited in claim 1, wherein the medium is a commercially available writable compact disc.

10. The method as recited in claim 1, wherein the medium is a commercially available writable digital video disc.

11. The method as recited in claim 1, wherein the medium is a commercially available writable optical medium.

12. The method as recited in claim 1, wherein the medium comprises a substantially transparent layer and a reflective layer, the electron pulses damaging the reflective layer.

13. The method as recited in claim 1, wherein the medium comprises a substantially transparent layer and a reflective layer, the electron pulses creating pits in the substantially transparent layer, the reflective layer being added after the surface features are created.

14. The method as recited in claim 1, wherein the medium comprises a reflective layer, and a dye layer being substantially transparent in an unexposed state, the electron pulses creating darkened portions of the dye layer.

15. The method as recited in claim 1, wherein the surface features have a length along a data track thereof of less than about 500 nanometers.

16. The method as recited in claim 1, wherein the surface features have a length along a data track thereof of less than about 200 nanometers.

17. The method as recited in claim 1, wherein the surface features have a length along a data track thereof of less than about 100 nanometers.

18. The method as recited in claim 1, wherein the surface features are created on at least two layers of the optical medium.

19. The method as recited in claim 1, wherein the beam is directed in the controlled pattern via magnetic fields.

20. The method as recited in claim 1, wherein the pulses are generated by controlling a grid voltage of the electron source.

21. The method as recited in claim 1, wherein the pulses are generated by beam blanking.

22. The method as recited in claim 1, wherein the data is written to the optical medium in less than about one minute.

23. The method as recited in claim 1, wherein the data is written to the optical medium in less than about one second.

24. A method for writing data to an optical medium, comprising:
directing intermittent pulses of a beam of electrons from an electron source onto an a disc-shaped optical medium in a spiral pattern for creating surface features on the optical medium, the surface features representing data.

25. The method as recited in claim 24, wherein the optical medium is readable by a consumer-grade compact disc (CD) player.

26. The method as recited in claim 24, wherein the optical medium is readable by a consumer-grade digital video disc (DVD) player.

27. The method as recited in claim 24, wherein the optical medium is readable by a reader capable of reading surface features finer than a consumer-grade digital video disc (DVD) player.

28. The method as recited in claim 24, wherein the medium is a commercially available compact disc.

29. The method as recited in claim 24, wherein the medium is a commercially available digital video disc.

30. The method as recited in claim 24, wherein the medium is a commercially available writable compact disc.

31. The method as recited in claim 24, wherein the medium is a commercially available writable digital video disc.

32. The method as recited in claim 24, wherein the medium is a commercially available writable optical medium.

33. The method as recited in claim 24, wherein the medium comprises a substantially transparent layer and a reflective layer, the electron pulses damaging the reflective layer.

34. The method as recited in claim 24, wherein the medium comprises a substantially transparent layer and a reflective layer, the electron pulses creating pits in the substantially transparent layer, the reflective layer being added after the surface features are created.

35. The method as recited in claim 24, wherein the medium comprises a reflective layer, and a dye layer being substantially transparent in an unexposed state, the electron pulses creating darkened portions of the dye layer.

36. The method as recited in claim 24, wherein the surface features have a length along a data track thereof of less than about 500 nanometers.

37. The method as recited in claim 24, wherein the surface features have a length along a data track thereof of less than about 200 nanometers.

38. The method as recited in claim 24, wherein the surface features have a length along a data track thereof of less than about 100 nanometers.

39. The method as recited in claim 24, wherein the surface features are created on at least two layers of the optical medium.

40. The method as recited in claim 24, wherein the beam is directed in the controlled pattern via magnetic fields.

41. The method as recited in claim 24, wherein the pulses are generated by controlling a grid voltage of the electron source.

42. The method as recited in claim 24, wherein the pulses are generated by beam blanking.

43. The method as recited in claim 24, wherein the data is written to the optical medium in less than about one minute.

44. The method as recited in claim 24, wherein the data is written to the optical medium in less than about one second.

45. A system for writing data to an optical medium, comprising:
a medium receiving portion for holding an optical medium;
an electron source for emitting a beam of electrons at the optical medium on the medium receiving portion; and
a steering mechanism for directing the electron beam onto the optical medium in a controlled manner,
wherein the beam of electrons strikes the optical medium in intermittent pulses for creating surface features on the optical medium, the surface features representing data.

46. The system as recited in claim 45, wherein the optical medium is a disc.

47. The system as recited in claim 46, wherein the pattern has a generally spiral shape.

48. The system as recited in claim 46, wherein the optical medium is readable by a consumer-grade compact disc (CD) player.

49. The system as recited in claim 46, wherein the optical medium is readable by a consumer-grade digital video disc (DVD) player.

50. The system as recited in claim 45, wherein the optical medium is readable by a reader capable of reading surface features finer than a consumer-grade digital video disc (DVD) player.

51. The system as recited in claim 45, wherein the medium is a commercially available compact disc.

52. The system as recited in claim 45, wherein the medium is a commercially available writable compact disc.

53. The system as recited in claim 45, wherein the medium is a commercially available writable digital video disc.

54. The system as recited in claim 45, wherein the medium is a commercially available writable optical medium.

55. The system as recited in claim 45, wherein the medium comprises a substantially transparent layer and a reflective layer, the electron pulses damaging the reflective layer.

56. The system as recited in claim 45, wherein the medium comprises a substantially transparent layer and a reflective layer, the electron pulses creating pits in the substantially transparent layer, the reflective layer being added after the surface features are created.

57. The system as recited in claim 45, wherein the medium comprises a reflective layer, and a dye layer being substantially transparent in an unexposed state, the electron pulses creating darkened portions of the dye layer.

58. The system as recited in claim 45, wherein the surface features have a length along a data track thereof of less than about 500 nanometers.

59. The system as recited in claim 45, wherein the surface features have a length along a data track thereof of less than about 200 nanometers.

60. The system as recited in claim 45, wherein the surface features have a length along a data track thereof of less than about 100 nanometers.

61. The system as recited in claim 45, wherein the surface features are created on at least two layers of the optical medium.

62. The system as recited in claim 45, wherein the steering mechanism includes steering coils that generate magnetic fields.

63. The system as recited in claim 45, wherein the pulses are generated by controlling a grid voltage of the electron gun.

64. The system, as recited in claim 45, wherein the pulses are generated by beam blanking.

65. The system as recited in claim 45, wherein the data is written to the optical medium in less than about one minute.

66. The system as recited in claim 45, wherein the data is written to the optical medium in less than about one second.

67. A system for writing data to an optical medium, comprising:
a medium receiving portion for holding a disc shaped optical medium;
an electron source for emitting a beam of electrons at the optical medium on the medium receiving portion; and
a steering mechanism for directing the electron beam onto the optical medium in a controlled manner,
wherein the beam of electrons strikes the optical medium in intermittent pulses for creating surface features on the optical medium, the surface features representing data.
